(19) United States
(12) Patent Application Publication
(10) Pub. No.: US 2023/0368039 A1
(43) Pub. Date: Nov. 16, 2023

(54) OBJECT PACKINGS

(71) Applicants: Hewlett-Packard Development Company, L.P., Spring, TX (US); Instituto Atlântico, Edson Queiroz, Fortaleza (BR)

(72) Inventors: Juan Carlos CATANA SALAZAR, San Diego, CA (US); Alyne GOMES SOARES CANTAL, Porto Alegre (BR); Andre Luiz LIMA PEDRO, Porto Alegre (BR); Scott Alan WHITE, Boise, ID (US); Jun Zeng, Palo Alto, CA (US)

(21) Appl. No.: 18/029,598

(22) PCT Filed: Oct. 2, 2020
(86) PCT No.: PCT/US2020/054072

§ 371 Date: Mar. 30, 2023

(51) Int. Cl. G06N 3/126; B33Y 10/00; B33Y 50/00

(52) U.S. Cl. CPC G06N 3/126; B33Y 10/00; B33Y 50/00

(57) ABSTRACT

Examples of methods for object packings are described herein. In some examples, a method includes generating chromosomes in a genetic procedure. In some examples, each chromosome indicates a packing of objects in a volume. In some examples, the method also includes determining uniformity scores corresponding to the chromosomes. In some examples, each uniformity score is based on object orientation similarity. In some examples, the method further includes selecting a chromosome based on the uniformity scores.

### BACKGROUND

Three-dimensional (3D) solid objects may be produced from a digital model using additive manufacturing. Additive manufacturing may be used in rapid prototyping, mold generation, mold master generation, and short-run manufacturing. Additive manufacturing involves the application of successive layers of build material. This is unlike some machining processes that often remove material to create the final object. In some additive manufacturing techniques, the build material may be cured or fused.

### BRIEF DESCRIPTION OF THE DRAWINGS

FIG. 1 is a flow diagram illustrating an example of a method for object packing;

FIG. 2 is a block diagram of an example of an apparatus that may be used in object packing;

FIG. 3 is a block diagram illustrating an example of a computer-readable medium for determining an object packing;

FIG. 4A is a diagram illustrating examples of sets of similarly oriented objects;

FIG. 4B is a diagram illustrating an example of a chromosome (e.g., packing) determined without using a uniformity score; and

FIG. 4C is a diagram illustrating an example of a chromosome (e.g., packing) determined using a uniformity score.

### DETAILED DESCRIPTION

Additive manufacturing may be used to manufacture three-dimensional (3D) objects. 3D printing is an example of additive manufacturing. Performing additive manufacturing may rely on a packing. A packing is information that specifies an arrangement (e.g., position, location, and/or orientation, etc.) of objects in a build volume. A build volume is a 3D space. A build volume may correspond to a physical space in which additive manufacturing may be performed. It may be helpful to increase packing density in the build volume to increase production and/or reduce manufacturing costs.

In some examples, object packing may be based on an objective or objectives. An example of an objective is packing density (e.g., increasing or maximizing packing density). Object packing questions may be computationally intensive to solve, being nondeterministic polynomial- (NP-) complete. For example, computational complexity may grow exponentially in NP-complete questions. For instance, the size of the solution space (e.g., number of possible packing arrangements) for placement of objects (without rotation, for example) in a relatively small batch of 20 objects, is beyond the order of 1 × 10¹⁸. Some examples of the techniques described herein may provide practical and/or near-optimal approaches for object packing. For instance, some of the techniques described herein may enable searching over the solution space while prioritizing portions that have a greater probability of producing a near-optimal solution. In some examples, a relatively small portion of the solution space may be searched.

Throughout the drawings, identical or similar reference numbers may designate similar, but not necessarily identical, elements. When an element is referred to without a reference number, this may refer to the element generally, without necessary limitation to any particular Figure. The figures are not necessarily to scale, and the size of some parts may be exaggerated to more clearly illustrate the example shown. Moreover, the drawings provide examples in accordance with the description; however, the description is not limited to the examples provided in the drawings.

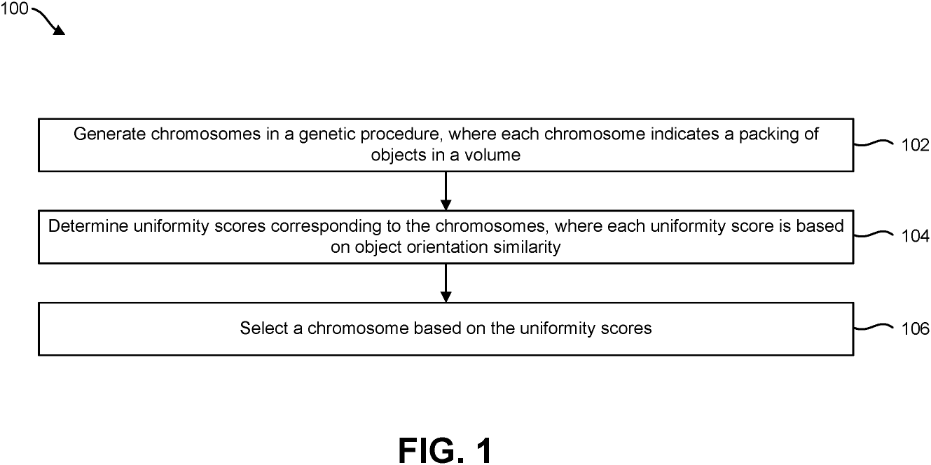

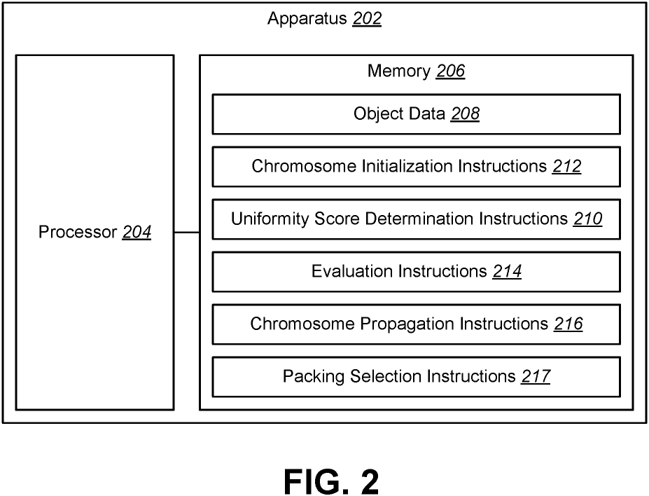

FIG. 1 is a flow diagram illustrating an example of a method 100 for object packing. The method 100 and/or a method 100 element or elements may be performed by an apparatus (e.g., electronic device). For example, the method 100 may be performed by the apparatus 202 described in relation to FIG. 2.

The apparatus may generate 102 chromosomes in a genetic procedure, where each chromosome indicates a packing of objects in a volume. A genetic procedure is a computational procedure. For example, a genetic procedure may be a metaheuristic procedure that includes evolution and/or selection mechanisms for determining a solution. In some examples, a genetic procedure may be a technique utilized in artificial intelligence. In some examples, the genetic procedure may include initializing a population, evaluation, selection, crossover, and/or mutation operations. In some examples, evaluation, selection, crossover, and/or mutation may be performed repeatedly (e.g., iteratively, recursively, etc.) until an end condition is met. In some examples, generating 102 the chromosomes may be performed in initializing a population, crossover, and/or mutation operations. A population is a group or set of chromosomes.

A chromosome is data. For example, a chromosome may include data representing a potential solution for a question that the genetic procedure is to address. For instance, a chromosome may indicate a packing of objects in a volume (e.g., build volume). A packing is an arrangement of objects. For instance, chromosomes may indicate packing positions. A packing position is a pose of an object in a build volume. In some examples, a chromosome may include data indicating a set of object identifiers and poses. An object identifier is information (e.g., number, floating point number, integer, string, character(s), name, etc.) that identifies an object. A pose is information indicating a location and/or orientation of an object. For instance, a pose may indicate a location (e.g., translation) of an object in a build volume and/or an orientation (e.g., rotation(s) in a dimension or dimensions) of an object in a build volume. In some examples, a pose may be expressed as a number or numbers (e.g., floating point numbers, integers, etc.), vector(s), matrix or matrices, quaternion(s), etc. In some examples, a chromosome may include an object identifier with a first axis rotation (e.g., x), a second axis rotation (e.g., y), and a third axis rotation (e.g., z) for each of a set of objects. In some examples, a chromosome may include an object identifier with an orientation (and without location, for instance) for each of a set of objects. In some examples, each gene of a chromosome may include an object identifier and/or pose (e.g., orientation and/or location).

In some examples, a chromosome may include data for each object in an order or sequence. In some examples, the order or sequence of a chromosome may correspond to a packing order in the volume (e.g., build volume). For instance, the apparatus may place the objects of a chromosome in the volume (e.g., build volume) in the order or sequence indicated in the chromosome. In some cases, consecutive objects in a chromosome may be placed adjacently in the volume if volume dimensions allow, to an extent that volume dimensions allow, and/or to an extent that previously-placed object(s) allow. In some examples, the order or sequence may establish a priority queue. For instance, the order or sequence may indicate an order that objects may be introduced into a build volume. In some examples, a chromosome may include an object identifier and rotations for respective objects from object 1 to object n. For instance, a chromosome may encode an object list, where each element of the list indicates an identifier of an object and/or rotation angles corresponding to axes (e.g., in x, y, and z axes). In some examples, the order or sequence of a chromosome may be an order or sequence of object identifiers. In some examples, each chromosome may represent a potential packing described as a sequence of object identifiers with associated poses.

In initializing a population, the apparatus may randomly initialize a set of chromosomes. For example, the apparatus may utilize a random number generator to generate random poses for a set of objects (to be packed in a build volume, for instance).

When packing similar or same objects (e.g., multiple copies of a same object), some packing solutions (with good density, for example) may include objects in symmetric orientation patterns and/or may nest sets of objects. In some cases, symmetric orientation patterns and/or nesting may be challenging to achieve with a genetic procedure. Due to the randomness of chromosome creation and/or evolution in genetic procedures, it may be challenging to promote packings with symmetric orientation patterns and/or nesting. Some examples of the techniques described herein may be utilized to encourage and/or achieve increased object packing density using a genetic procedure or procedures.

The apparatus may determine 104 uniformity scores corresponding to the chromosomes. A uniformity score is a value or measure that indicates a degree of uniformity. For example, a uniformity score may indicate a degree of uniformity of a chromosome (e.g., packing). In some examples, each uniformity score may be based on object orientation similarity. Object orientation similarity is similarity in terms of orientation (e.g., rotation) relative to another orientation (e.g., orientation of another object or a default orientation). For instance, a uniformity score may indicate a degree to which objects in a chromosome (e.g., packing) are oriented similarly. For instance, a uniformity score may quantify symmetric orientation patterns and/or nested sets of objects for assessing a chromosome (e.g., packing).

In some examples, determining 104 the uniformity scores may include determining whether each of the chromosomes includes a set or sets of objects that meet an orientation similarity criterion. An orientation similarity criterion is a condition or conditions in which an object is oriented similarly to another object. In some examples, a set of objects may meet an orientation similarity criterion if the objects have a same orientation and/or are within a range (e.g., an angular range for an axis or axes) relative to another object in the set. For instance, determining 104 the uniformity scores may include determining, for each of the chromosomes, a quantity of sets of objects that meet an orientation similarity criterion. For example, each set of objects that meets the orientation similarity criterion of a chromosome may be counted to produce a uniformity score for the chromosome.

In some examples, a set of objects (e.g., a “pile,” “nested pile,” etc., of objects) that meets an orientation similarity criterion may be a group, set, and/or subset of objects in the volume (e.g., build volume) that are consecutively placed (e.g., placed one after another following a direction or an axis direction) and that have a same orientation (or an orientation within a range or ranges, for instance) or follow a symmetric pattern. For instance, a subset of objects may be nested like a stack of plates. In some examples, a chromosome, packing, and/or build volume may include multiple sets of similarly oriented objects. In some examples, a uniformity score may be computed by counting a quantity of sets of similarly oriented objects (e.g., sets that meet an orientation similarity criterion, nested piles, etc.) in a chromosome, packing, or volume (e.g., build volume).

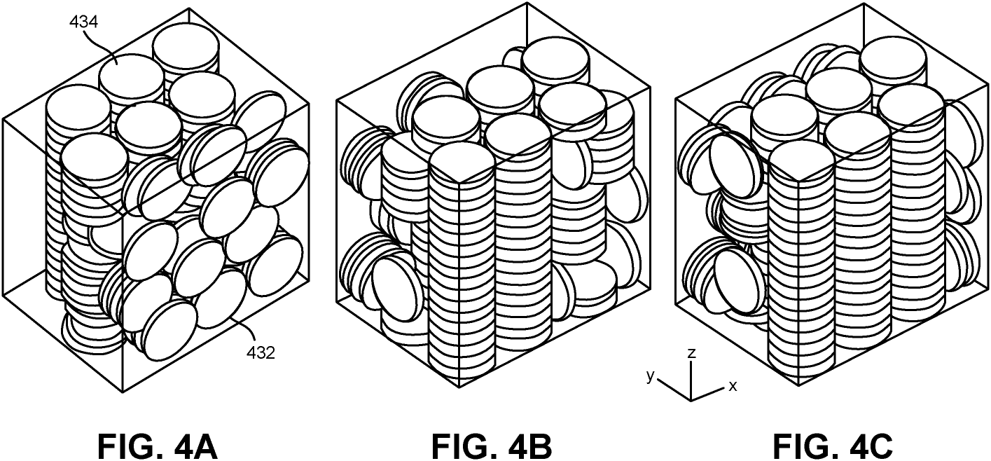

In some examples, the orientation similarity criterion may include an orientation condition (e.g., objects with similar orientations, same orientations, and/or orientations within rotational threshold(s), etc.) and/or a sequence condition (e.g., objects within a continuous sequence of a chromosome). An orientation condition is a condition relating to orientation (e.g., relative orientation between objects). A sequence condition is a condition in which items occur in an order or sequence (e.g., consecutively). For instance, a chromosome may include a continuous sequence or continuous sequences of objects with similar orientations. A continuous sequence of objects with similar orientations may be a range of consecutively ordered objects in a chromosome. In some examples, the orientation condition may include a range or ranges (e.g., rotational range or ranges, angular range or ranges, threshold(s), ±1 degree, ±2 degrees, etc., from the orientation of an object) on an axis or axes, and/or a 180-degree relative rotation (in a case of symmetry across an axis of the rotation, for instance), and/or range(s) from the 180-degree relative rotation. For instance, the orientation similarity criterion may be met for objects that are within a first rotational range of an object or within a second rotational range of a 180-degree relative rotation of the object in a case of symmetry across an axis of the rotation. For example, some objects may be symmetrical (or nearly symmetrical, for instance) over an axis of rotation or axes of rotation. In some examples, objects may meet the orientation similarity criterion if an object is symmetrical over an axis of rotation and the object is rotated 180 degrees on that axis with respect to another object. In some examples, the rotational range(s) may be constrained to a specific orientation or orientations (e.g., a single value or values, the same orientation or a 180-degree relative rotation, etc.). FIG. 4A illustrates examples of sets of similarly oriented objects.

In some examples, the uniformity score may be utilized to increase (e.g., maximize) packing density by increasing (e.g., maximizing) the size of sets of similarly oriented objects (e.g., sets that meet an orientation similarity criterion, nested piles, etc.), For instance, some of the techniques described herein may be utilized to increase (e.g., maximize) the quantity of similarly oriented objects (e.g., objects that meet an orientation similarity criterion, nested objects, etc.) in a set (e.g., pile) and reduce (e.g., minimize) the quantity of different sets (e.g., nested piles) in the volume (e.g., build volume). In some examples, the uniformity score may be utilized to evaluate and/or rank the chromosomes (e.g., packings).

In performing evaluation, the apparatus may evaluate and/or rank the chromosomes according to a value or values. Examples of values include quantity of objects packed, a fitness measure, and/or uniformity score. The quantity of objects packed is a quantity of objects that fit within the volume (e.g., build volume) for a chromosome. A quantity of objects packed may be determined for each chromosome.

A fitness measure is a measure that indicates a degree to which a chromosome (e.g., packing) satisfies an objective or objectives (e.g., increased packing density, decreased packing height, and/or decreased z-axis measure, etc.). For example, the fitness measure may be evaluated for each chromosome (e.g., packing). Examples of fitness measures may include packing density, and/or packing height (e.g., z-height).

In some examples, a value or values (e.g., quantity of objects packed, fitness measure, and/or uniformity score) may be utilized to rank or order chromosomes. In some examples, a group of values (e.g., quantity of objects packed, fitness measure, and/or uniformity score) may be assembled and/or combined to form a packing score that can be utilized to rank one packing over another packing. For instance, a packing score may be determined based on a function, combination, mapping, weighted sum, average, etc., of multiple values (e.g., quantity of objects packed, fitness measure, and/or uniformity score). In some examples, chromosomes with a relatively greater packing density, a relatively greater quantity of objects packed, a relatively lesser packing height, and/or a relatively lower uniformity score (with a relatively smaller quantity of sets of similarly oriented objects and/or with relatively larger numbers of objects per set, for instance) may be ranked higher than other chromosomes.

The apparatus may select 106 a chromosome based on the uniformity scores. For example, selecting 106 a chromosome may include chromosome selection for propagation (e.g., mutation and/or crossover) and/or packing (e.g., selecting a chromosome for a packing solution). For instance, the apparatus may select 106 a chromosome or chromosomes based on a rank that is based on quantities of objects packed, fitness scores, and/or uniformity scores.

In some examples, selecting 106 a chromosome may be based on a value or values. For instance, selecting 106 a chromosome may be based on a lowest uniformity score (e.g., selecting a chromosome with a lowest uniformity score). For example, a chromosome with a lowest uniformity score may be selected for propagation and/or packing. In some examples, selecting 106 the chromosome is based on a quantity of objects packed. For instance, a chromosome with a greatest quantity of objects packed may be selected for propagation and/or packing. In some examples, selecting 106 the chromosome is based on a fitness score. For instance, a chromosome with a best fitness score (e.g., highest packing density and/or lowest height) may be selected for propagation and/or packing.

In some examples, in the genetic procedure, a criterion or criteria for chromosome selection may be based on the number of packed parts, fitness score (e.g., packing density and/or height) and/or uniformity score. For example, when two chromosomes (or multiple chromosomes) have an equal number of packed parts and equal fitness scores (e.g., packing densities and/or heights), the apparatus may utilize the uniformity score as a tiebreaker criterion.

In performing selection, the apparatus may eliminate a portion of the chromosomes. For instance, the apparatus may eliminate (e.g., discard, delete, remove, exclude, etc.) a portion of the lowest ranked chromosomes (e.g., a percentage of lowest ranked chromosomes, a quantity of lowest ranked chromosomes, etc.). In some examples, the chromosomes may be categorized based on rank. For example, a first portion (e.g., percentage of chromosomes, number of chromosomes, etc.) of the chromosomes may be categorized in a first category. For instance, the first portion may be a set of highest ranked chromosomes. The first portion of chromosomes may be referred to as elite chromosomes (e.g., a portion of chromosomes with best values, quantities of objects packed, fitness measures, and/or uniformity scores). In some examples, a gene or genes (e.g., object identifier(s) and/or pose(s)) of the elite chromosomes may be preserved and/or propagated to a subsequent (e.g., next) generation of chromosomes. A generation is a set of chromosomes (e.g., packings). For example, a generation may correspond to each iteration of the genetic procedure.

In performing crossover, the apparatus may utilize a second portion of chromosomes and elite chromosomes. The second portion of the chromosomes may be referred to as crossover chromosomes. The second portion of chromosomes may be ranked below the elite chromosomes. For instance, the apparatus may randomly select chromosomes that are ranked below the elite chromosomes to select the crossover chromosomes. The apparatus may crossover the crossover chromosomes with the elite chromosomes. For example, the apparatus may combine a portion or portions (e.g., gene(s), object identifier(s), pose(s), location(s), orientation(s), rotation(s), and/or sequence position(s)) of an elite chromosome with a portion or portions (e.g., gene(s), object identifier(s), pose(s), location(s), orientation(s), rotation(s), and/or sequence position(s)) of a crossover chromosome to generate a child chromosome in a subsequent (e.g., next) generation of chromosomes.

In performing mutation, the apparatus may randomly mutate an elite chromosome or elite chromosomes. For example, the apparatus may randomly change a gene or genes (e.g., object identifier(s), pose(s), location(s), orientation(s), rotation(s), and/or sequence position(s)) of an elite chromosome or elite chromosomes. The chromosomes to be mutated may be referred to as mutation chromosomes.

In some examples, a constant population size (e.g., number of chromosomes) may be maintained over generations. In some examples, the population size may vary over generations. In some examples, new random chromosomes may be added. For instance, a set of randomly generated chromosomes may be added to the elite chromosomes, crossover chromosomes, and mutation chromosomes. For instance, adding new random chromosomes may maintain the constant population size. The random chromosomes may be useful for driving a random search in different directions in the solution space. In some approaches, mutations of chromosomes may be represented as random movements in the object sequence and/or random rotations on the object orientations. The mutation stage may be utilized to mutate elite chromosomes (e.g., good solutions) into chromosomes with increased fitness (e.g., better solutions). Performing selection, crossover, and/or mutation may produce a subsequent generation of chromosomes.

In some examples, the method 100 may repeat (e.g., iterate, recur, etc.). For example, the method 100 may be repeated for subsequent generations of chromosomes until an end condition is met (e.g., a threshold number of generations, a threshold quantity of packed objects, a threshold fitness score, a threshold uniformity score, and/or a threshold packing score, etc.).

In some examples, the method 100 may include selecting based on the chromosomes (e.g., chromosomes after a generation or generations). In some examples, selecting the packing is based on the genetic procedure with an objective to increase packing density. For instance, the apparatus may select a chromosome that represents a packing with a highest ranking, best value(s), best packing score, maximum quantity of packed objects, best fitness score (e.g., maximum packing density or minimum height), and/or minimum uniformity score. In some examples, the apparatus may select the packing based on an objective (e.g., packing density) or a combination of objectives. For instance, a packing with a best combination of objectives, such as quantity of packed objects, packing density, packing height, fitness score, and/or uniformity score, may be selected.

In some examples, the packing may be executed to manufacture the objects. For example, the objects may be manufactured by an apparatus (e.g., 3D printer) in accordance with the selected packing. For instance, an apparatus may send the packing to another device (e.g., 3D printer) or may execute the packing to manufacture the objects in the packing. Some examples of the techniques described herein may be utilized in a variety of additive manufacturing. Some additive manufacturing techniques may be powder-based and driven by powder fusion. Some additive manufacturing techniques may include metal printing, such as metal jet fusion. Some examples of the approaches described herein may be utilized in powder bed fusion-based additive manufacturing, such as Selective Laser Melting (SLM), Selective Laser Sintering (SLS), Multi-Jet Fusion (MJF), etc.

In some examples, the method 100 may include presenting the selected packing. For instance, the apparatus may send an image of the packing to a display for presentation. In some examples, the method 100 may include sending the selected packing to another device (e.g., computing device, server, etc.). For instance, the apparatus may transmit the selected packing to another device via a network (e.g., a local area network, the Internet, etc.).

FIG. 2 is a block diagram of an example of an apparatus 202 that may be used in object packing. The apparatus 202 may be an electronic device, such as a personal computer, a server computer, a printer, a 3D printer, a smartphone, a tablet computer, etc. The apparatus 202 may include and/or may be coupled to a processor 204 and/or a memory 206. In some examples, the apparatus 202 may be in communication with (e.g., coupled to, have a communication link with) an additive manufacturing device (e.g., a 3D printing device). In some examples, the apparatus 202 may be an example of a 3D printing device. The apparatus 202 may include additional components (not shown) and/or some of the components described herein may be removed and/or modified without departing from the scope of the techniques described herein.

The processor 204 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 206. The processor 204 may fetch, decode, and/or execute instructions (e.g., chromosome initialization instructions 212, uniformity score determination instructions 210, evaluation instructions 214, chromosome propagation instructions 216, and/or packing selection instructions 217) stored in the memory 206. In some examples, the processor 204 may include an electronic circuit or circuits that include electronic components for performing a function or functions of the instructions (e.g., chromosome initialization instructions 212, uniformity score determination instructions 210, evaluation instructions 214, chromosome propagation instructions 216, and/or packing selection instructions 217). In some examples, the processor 204 may perform one, some, or all of the functions, operations, elements, methods, etc., described in relation to one, some, or all of FIGS. 1-4A or 4C.

The memory 206 may be any electronic, magnetic, optical, or other physical storage device that contains or stores electronic information (e.g., executable instructions, executable code, and/or data). The memory 206 may be, for example, Random Access Memory (RAM), Electrically Erasable Programmable Read-Only Memory (EEPROM), a storage device, an optical disc, and the like. In some examples, the memory 206 may be volatile and/or non-volatile memory, such as Dynamic Random Access Memory (DRAM), EEPROM, magnetoresistive random-access memory (MRAM), phase change RAM (PCRAM), memristor, flash memory, and the like. In some examples, the memory 206 may be a non-transitory tangible machine-readable storage medium, where the term “non-transitory” does not encompass transitory propagating signals. In some examples, the memory 206 may include multiple devices (e.g., a RAM card and a solid-state drive (SSD)).

In some examples, the apparatus 202 may include an input/output interface (not shown in FIG. 2) through which the processor 204 may communicate with an external device or devices (not shown), for instance, to receive and store information (e.g., object data 208) pertaining to an object or objects to be manufactured (e.g., printed). The input/output interface may include hardware and/or machine-readable instructions to enable the processor 204 to communicate with the external device or devices. The input/output interface may enable a wired or wireless connection to the external device or devices. The input/output interface may further include a network interface card and/or may also include hardware and/or machine-readable instructions to enable the processor 204 to communicate with various input and/or output devices, such as a keyboard, a mouse, a display, another apparatus, electronic device, computing device, etc., through which a user may input instructions into the apparatus 202.

In some examples, the memory 206 may store object data 208. The object data 208 may be obtained (e.g., received) from an external device and/or may be generated on the apparatus 202. For example, the processor 204 may execute instructions (not shown in FIG. 2) to receive the object data 208 from an external device.

The object data 208 may include data indicating objects and/or shapes (e.g., 3D models, dimensions, etc.) of objects. For example, the object data 208 may indicate objects for packing and/or manufacture. In some examples, the object data 208 may indicate same or similar objects. For instance, objects to be packed may include any number of objects that are the same or similar in some cases.

In some examples, the processor 204 may execute the chromosome initialization instructions 212 to initialize a population of chromosomes (e.g., packings) in a population based on object data 208. For example, the processor 204 may determine a random initial population of chromosomes. In some examples, determining the set of chromosomes may include randomizing chromosomes. For instance, the processor 204 may randomize object pose (e.g., location and/or orientation) in a build volume. In some examples, a chromosome may include a sequence of objects with corresponding orientations.

In some examples, the processor 204 may execute uniformity score determination instructions 210 to determine sets of objects that meet an orientation similarity criterion in a chromosome corresponding to a build volume to produce a uniformity score. In some examples, determining sets of objects that meet an orientation similarity criterion in a chromosome corresponding to a build volume to produce the uniformity score may be performed as described in relation to FIG. 1. For instance, the processor 204 may determine a quantity of sets of objects (e.g., piles, nested piles, etc.) that meet an orientation similarity criterion for a chromosome or chromosomes. In some examples, sets of objects that meet an orientation similarity criterion may be in continuous (e.g., consecutive) ranges of a chromosome.

In some examples, the processor 204 may execute the evaluation instructions 214 to evaluate the chromosome(s) based on the uniformity score(s). In some examples, evaluating the chromosome(s) may be performed as described in relation to FIG. 1. For example, the processor 204 may rank the chromosome(s) based on the uniformity score and/or a value or values (e.g., quantity(ies) of packed objects, fitness score(s), packing density(ies), and/or packing height(s)).

In some examples, the processor 204 may execute the chromosome propagation instructions 216 to propagate a chromosome or chromosomes in a case that the evaluation is satisfied. In some examples, propagating the chromosome(s) in a case that the evaluation is satisfied may be performed as described in relation to FIG. 1. For example, the processor 204 may propagate (e.g., mutate and/or crossover) a chromosome or chromosomes that are above a ranking threshold. The apparatus 202 (e.g., processor 204) may iterate evaluating and propagating chromosomes for a generation or generations in some approaches.

In some examples, the processor 204 may execute the packing selection instructions 217 to select a packing based on the chromosome(S). For example, the processor 204 may select a chromosome as a packing with a maximum quantity of packed objects, best fitness measure, minimum uniformity score, and/or best packing score from the chromosomes. In some examples, the apparatus 202 may perform manufacturing based on the selected packing. For example, the apparatus 202 may 3D print the selected packing and/or send the selected packing to a 3D printer for manufacture.

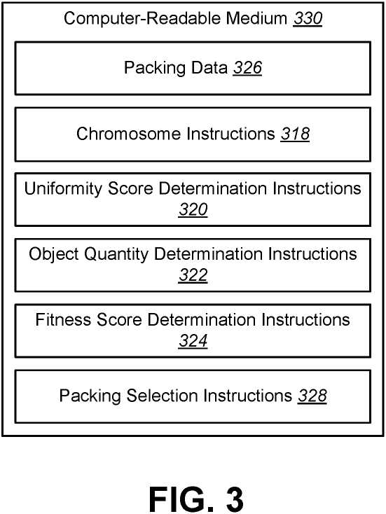

FIG. 3 is a block diagram illustrating an example of a computer-readable medium 330 for determining an object packing. The computer-readable medium is a non-transitory, tangible computer-readable medium 330. The computer-readable medium 330 may be, for example, RAM, EEPROM, a storage device, an optical disc, and the like. In some examples, the computer-readable medium 330 may be volatile and/or non-volatile memory, such as DRAM, EEPROM, MRAM, PCRAM, memristor, flash memory, and the like. In some examples, the memory 206 described in relation to FIG. 2 may be an example of the computer-readable medium 330 described in relation to FIG. 3.

The computer-readable medium 330 may include code (e.g., data and/or instructions). For example, the computer-readable medium 330 may include packing data 326, chromosome instructions 318, uniformity score determination instructions 320, object quantity determination instructions 322, fitness score determination instructions 324, and/or packing selection instructions 328.

The packing data 326 may include information indicating a plurality of packings. For example, the packing data 326 may indicate a set of packings, a group of packings, a population of packings, and/or generations of packings. For instance, operations may be performed as described herein to determine a plurality of chromosomes that represent packings. The chromosomes may be stored as packing data 326.

In some examples, the chromosome instructions 318 are code to cause a processor to create a chromosome. For instance, the chromosome instructions 318 may be instructions to cause a processor to generate a chromosome, crossover chromosomes, and/or mutate a chromosome to create the chromosome. In some examples, the chromosome may be created as described in relation to FIG. 1 and/or FIG. 2.

In some examples, the chromosome instructions 318 may include code to cause the processor to determine a set or sets of objects that meet an orientation condition and a sequence condition in a chromosome. For instance, consecutive objects (e.g., genes) in the chromosome may be placed in order in the volume (e.g., build volume). In some examples, determining the set(s) of objects that meet an orientation condition and a sequence condition in a chromosome may be performed as described in relation to FIG. 1 and/or FIG. 2. For instance, if consecutively ordered objects are within rotational thresholds (e.g., the same orientation, within ±1 degree, at a 180-degree rotation, and/or within ±1 degree from the 180-degree rotation, etc.) from one of the objects, the orientation condition and the sequence condition may be met.

In some examples, the uniformity score determination instructions 320 are code to cause the processor to quantify the set(s) to produce a uniformity score for the chromosome. For example, the processor may execute the uniformity score determination instructions 320 to count the number of sets of objects that meet the orientation condition in the chromosome that are in consecutive order. In some examples, quantifying the set(s) may be accomplished as described in relation to FIG. 1 and/or FIG. 2.

In some examples, the object quantity determination instructions 322 are code to cause the processor to determine a quantity of objects of the chromosome in the volume. For example, the processor may execute the object quantity determination instructions 322 to determine, look-up, count, etc., the quantity of objects of the chromosome in the volume. In some examples, determining the quantity of objects of the chromosome in the volume may be accomplished as described in relation to FIG. 1 and/or FIG. 2.

In some examples, the fitness score determination instructions 324 are code to cause the processor to determine a fitness score of the chromosome. For instance, the processor may execute the fitness score determination instructions 324 to determine a packing density and/or packing height (e.g., z-dimension) of the packing indicated by the chromosome. For instance, the fitness score may be a height of the chromosome and/or a packing density of the chromosome. In some examples, determining the fitness score of the chromosome may be performed as described in relation to FIG. 1 and/or FIG. 2.

In some examples, the packing selection instructions 328 are code to cause the processor to determine a packing based on the uniformity score and the fitness score. In some examples, the packing selection instructions 328 are code to cause the processor to determine a packing based on the uniformity score, the quantity of objects, and the fitness score. For instance, the packing selection instructions 328 may cause a processor to determine a best packing in terms of quantity of objects, fitness score, and/or uniformity score from a set (e.g., generation or generations) of chromosomes. In some examples, determining the packing may be performed as described in relation to FIG. 1 and/or FIG. 2.

In some examples, the packing selection instructions 328 may include code to cause the processor to rank chromosomes with hierarchical criteria based on quantities of objects, fitness scores, and/or uniformity scores. The hierarchical criteria may include criteria with varying priority. For instance, the quantity of objects may be a criterion with a top priority, the fitness score may be a criterion with a next lower priority (e.g., medium priority), and the uniformity score may be a criterion with a next lower priority (e.g., lowest priority). In the hierarchical criteria, the processor may determine if there is a chromosome (e.g., packing) with a best top priority criterion. If there is more than one chromosome with a best top priority criterion (e.g., multiple chromosomes with the same maximum quantity of packed objects), the selection may utilize the next lowest criterion. If there is more than one chromosome with a best next lowest criterion (e.g., multiple chromosomes with the same fitness scores or fitness scores within a range), the selection may utilize the next lower priority criterion (e.g., lowest priority). For example, the chromosome with a best uniformity score may be selected.

To determine a packing in some examples, packing scores may be compared. A packing score is a score indicating a value or a combination of values (e.g., quantity of objects packed, fitness score, and/or uniformity score). An example of packing selection is given as follows. Assume two packings A and B with corresponding packing scores s_A and s_B. In some examples, a packing score s_X may include parameters (e.g., k parameters or values): s_X = {p1_X, p2_X, ..., pk_X}, where px_X is a parameter or value. A quantity (e.g., k) of threshold values may be utilized: α, β, ..., φ. If the first k-1 parameters of each packing are relatively closer to each other (up to an adjustable threshold), a Boolean value of (p1_A > p1_B) may indicate whether s_A is greater than s_B. For instance, In a case that abs(p1_A - p1_B) < α and abs(p2_A - p2_B) < β and so on for the rest of the parameters, and (pk_A != pk_B), then a Boolean value of (pk_A > pk_B) may indicate whether s_A is greater than s_B. Otherwise, a parameter number k-1 may be compared. For instance, in a case that abs(p1_A - p1_B) < α and abs(p2_A - p2_B) < β and so on for the rest of the parameters, and (pk-1_A != pk-1_B), then a Boolean value of (pk-1_A > pk-1_B) may indicate whether s_A is greater than s_B. Otherwise, similar comparisons may be made for a parameter or parameters (e.g., pk-2_A != pk-2_B and so on) until the final case, where (p1_A > p1_B) may indicate whether s_A is greater than s_B. The packing with the greatest score may be selected. In some examples, one parameter or multiple parameters (e.g., values) may be utilized in the comparison.

In some examples, the computer-readable medium 330 may include code for causing a processor to manufacture the selected packing. For example, the code may cause a processor to execute instructions and/or send instructions to another device (e.g., 3D printer) to manufacture the selected packing.

FIG. 4A is a diagram illustrating examples of sets of similarly oriented objects. For instance, FIG. 4A illustrates a first set 434 (e.g., first pile) of similarly oriented objects (e.g., a set of objects that meet the orientation similarity criterion with respect to a first object) and a second set 432 (e.g., second pile) of similarly oriented objects (e.g., a set of objects that meet the orientation similarity criterion with respect to a second object) in accordance with some of the techniques described herein. For instance, the first set 434 includes objects with a same orientation (or orientations with a 180-degree rotation due to symmetry). The first set 434 may correspond to a continuous (e.g., consecutive) sequence in the chromosome. The second set 432 includes objects with a same orientation (or orientations with a 180-degree rotation due to symmetry). The second set 432 may correspond to another continuous (e.g., consecutive) sequence in the chromosome. In accordance with some examples of the techniques described herein, the chromosome (e.g., packing) illustrated in FIG. 4A has a uniformity score of 2. Some of the techniques described herein may utilize uniformity score to drive chromosomes (e.g., packings) to increase (e.g., maximize) the sizes of each set of similarly oriented objects, before creating new sets with different orientations.

FIG. 4B is a diagram illustrating an example of a chromosome (e.g., packing) determined without using a uniformity score. In this example, the chromosome (e.g., packing) includes 134 objects in a build volume of 380 millimeters (mm) × 284 mm × 380 mm, with a packing density of 17.81%.

FIG. 4C is a diagram illustrating an example of a chromosome (e.g., packing) determined using a uniformity score. In this example, the chromosome (e.g., packing) includes 142 objects in a build volume of 380 mm × 284 mm × 380 mm, with a packing density of 18.82%. For instance, using the uniformity score increased packing density by about 1%. For example, utilizing some of the techniques described herein with the uniformity score may result in larger sets (e.g., piles). Accordingly, utilizing the uniformity score may lead to increased space usage by promoting sets with similar orientations (e.g., same or symmetric orientations) and/or nested sets.

It may be useful to increase packing density, which may increase production throughput and/or reduce manufacturing cost for 3D printing. Some of the techniques described herein may increase packing density. Some examples may employ a heuristic technique for packing multiple copies of a geometry (e.g., object). Some of the techniques described herein may utilize a genetic procedure. Some examples may provide packing techniques that can achieve higher packing density compared to some other approaches. For instance, some of the techniques include assessing chromosome characteristics in genetic procedures with a uniformity score to increase packing density for multiple copies of a geometry (e.g., object).

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be implemented within the scope of the disclosure. For example, aspects or elements of the examples described herein may be omitted or combined.

1. A method, comprising:
generating chromosomes in a genetic procedure, wherein each chromosome indicates a packing of objects in a volume;
determining uniformity scores corresponding to the chromosomes, wherein each uniformity score is based on object orientation similarity; and
selecting a chromosome based on the uniformity scores.

2. The method of claim 1, wherein determining the uniformity scores comprises determining whether each of the chromosomes includes a set or sets of objects that meet an orientation similarity criterion.

3. The method of claim 1, wherein determining the uniformity scores comprises determining, for each of the chromosomes, a quantity of sets of objects that meet an orientation similarity criterion.

4. The method of claim 3, wherein the orientation similarity criterion comprises an orientation condition and a sequence condition.

5. The method of claim 4, wherein a sequence of the chromosome corresponds to a packing order in the volume.

6. The method of claim 3, wherein the orientation similarity criterion is met for objects that are within a rotational range of an object or within a second rotational range of a 180-degree relative rotation of the object in a case of symmetry across an axis of the rotation.

7. The method of claim 1, wherein selecting the chromosome is based on a lowest uniformity score.

8. The method of claim 1, wherein selecting the chromosome is further based on a quantity of objects packed.

9. The method of claim 1, wherein selecting the chromosome is further based on a fitness score.

10. An apparatus, comprising:
a memory;
a processor coupled to the memory, wherein the processor is to:
determine sets of objects that meet an orientation similarity criterion in a chromosome corresponding to a build volume to produce a uniformity score;
evaluate the chromosome based on the uniformity score; and
propagate the chromosome in a case that the evaluation is satisfied.

11. The apparatus of claim 10, wherein the chromosome comprises a sequence of objects with corresponding orientations.

12. The apparatus of claim 11, wherein the sets of objects that meet the orientation similarity criterion are in continuous ranges of the chromosome.

13. A non-transitory tangible computer-readable medium storing executable code, comprising:
code to cause a processor to determine sets of objects in a chromosome that meet an orientation condition and a sequence condition;
code to cause the processor to quantify the sets to produce a uniformity score for the chromosome;
code to cause the processor to determine a fitness score of the chromosome; and
code to cause the processor to determine a packing based on the uniformity score and the fitness score.

14. The computer-readable medium of claim 13, wherein the fitness score is a height of the chromosome or a packing density of the chromosome.

15. The computer-readable medium of claim 13, wherein the code to cause the processor to determine the packing comprises code to cause the processor to rank chromosomes with hierarchical criteria based on quantities of objects, fitness scores, or uniformity scores.
